(19) United States
(12) Patent Application Publication
(10) Pub. No.: US 2017/0213164 A1
(43) Pub. Date: Jul. 27, 2017

(54) SYSTEMS AND METHODS FOR AUTONOMOUS VEHICLE RIDE RELEASE CONFIRMATION

(71) Applicant: GM GLOBAL TECHNOLOGY OPERATIONS LLC, Detroit, MI (US)

(72) Inventors: JIM K. RAINBOLT, HASLETT, MI (US); NATHANIEL H. WILLIAMS, BERKLEY, MI (US); DWAYNE A. CROCKER, LAKE ORION, MI (US); JANET S. GOINGS, COMMERCE TOWNSHIP, MI (US); MARY E. DECALUWE, OXFORD, MI (US)

(73) Assignee: GM GLOBAL TECHNOLOGY OPERATIONS LLC, Detroit, MI (US)

(21) Appl. No.: 15/413,011

(22) Filed: Jan. 23, 2017

Related U.S. Application Data
(60) Provisional application No. 62/287,432, filed on Jan. 26, 2016.

(51) Int. Cl. G06Q 10/02; B60W 40/08

(52) U.S. Cl. CPC G06Q 10/02; B60W 40/08; B60W 2040/0881; B60W 2040/089; B60W 2550/402; B60W 2550/406

(57) ABSTRACT

Methods, autonomous vehicles, and servers for passenger service in an autonomous vehicle are provided. A method includes receiving at least one signal indicating a status of at least one passenger of the autonomous vehicle. The method further includes processing the at least one signal to determine whether the at least one passenger has taken action consistent with completion of the passenger service reservation in the absence of an action that is inconsistent with completion of the passenger service reservation. The method yet further includes completing the reservation based on the processing the at least one signal. A server includes a processor and a non-transitory computer readable medium storing instructions that configure the server for performing the method.

### CROSS-REFERENCE TO RELATED APPLICATIONS

This application claims the benefit of U.S. Provisional Application No. 62/287,432 filed on Jan. 26, 2016. The disclosure of the above application is incorporated herein by reference.

### TECHNICAL FIELD

Embodiments of the subject matter described herein relate generally to autonomous vehicle passenger services, and more particularly relates to methods and systems for confirming the conclusion and release of a reservation for a ride in an autonomous vehicle.

### BACKGROUND

An autonomous vehicle is a vehicle that is capable of sensing its environment and navigating with little or no user input. An autonomous vehicle senses its environment using sensing devices such as radar, lidar, image sensors, etc. The autonomous vehicle system further uses information from systems such as global positioning systems (GPS) to navigate.

Application based transportation services are becoming increasingly popular. Conventional application based transportation services connect a user with a local driver who is available to take the user from point A to point B. The driver typically uses their own personal vehicle to transport the user. In these conventional transportation services the driver is able to visually and verbally confirm that the passenger has completed the trip or reservation.

In some instances, it would be desirable to use autonomous vehicles instead of driver based vehicles for the transportation. In such instances, however, a driver may not be present in the vehicle to verbally and visually confirm conclusion of a trip or reservation. In such instances, it may be difficult to determine when the trip or reservation has concluded. Premature or otherwise inaccurate conclusion of a reservation is typically quite undesirable to the passenger.

Accordingly, it is desirable to provide methods and systems for confirming the conclusion and release of a reservation for a ride in an autonomous vehicle. Furthermore, other desirable features and characteristics of the present invention will become apparent from the subsequent detailed description and the appended claims, taken in conjunction with the accompanying drawings and the foregoing technical field and background.

### SUMMARY

Methods, autonomous vehicles, and servers are provided for passenger service reservation in an autonomous vehicle. In one embodiment, a method includes receiving at least one signal indicating a status of at least one passenger of the autonomous vehicle. The method further includes processing the at least one signal to determine whether the at least one passenger has taken action consistent with completion of the passenger service reservation in the absence of an action that is inconsistent with completion of the passenger service reservation. The method yet further includes completing the reservation based on the processing the at least one signal.

In one embodiment, a server includes a processor, a transceiver in communication with an autonomous vehicle, and a non-transitory computer readable medium storing instructions. The instructions configure the server for interacting with at least one remote device. The instructions further configure the server for receiving at least one signal indicating a status of at least one passenger of the autonomous vehicle. The instructions yet further configure the server for processing the at least one signal to determine whether the at least one passenger has taken action consistent with completion of the passenger service reservation in the absence of an action that is inconsistent with completion of the passenger service reservation. The instructions yet still further configure the server for completing the reservation based on the processing the at least one signal.

In one embodiment, an autonomous vehicle includes a transceiver, a passenger cabin, and a controller. The transceiver is in wireless communication with an off-board server to receive passenger service instructions associated with a passenger service reservation. The passenger cabin is to house at least one passenger along a route corresponding to the passenger service instructions. The controller is programmed to: receive at least one signal indicating a status of at least one passenger, process the at least one signal to determine whether the at least one passenger has taken action consistent with completion of the passenger service reservation in the absence of an action that is inconsistent with completion of the passenger service reservation; transmit a reservation completion signal to the off-board server based on the processing the at least one signal; and authorize departure of the autonomous vehicle from a terminal destination of the passenger service reservation based on the processing the at least one signal.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a simplified diagram that illustrates an autonomous vehicle at the conclusion of an autonomous passenger ride service reservation in accordance with the teachings of the present disclosure;

FIG. 2 is a simplified block diagram of an exemplary control system of the autonomous vehicle illustrated in FIG. 1; and

FIG. 3 is a flow chart that illustrates an exemplary embodiment of a method for concluding an autonomous passenger ride reservation.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. In certain embodiments, the program or code segments are stored in a tangible processor-readable medium, which may include any medium that can store or transfer information. Examples of a non-transitory and processor-readable medium include an electronic circuit, a semiconductor memory device, a ROM, a flash memory, an erasable ROM (EROM), a floppy diskette, a CD-ROM, an optical disk, a hard disk, or the like.

For the sake of brevity, conventional techniques related to the control and operation of autonomous (i.e., driverless or self-driving) vehicles, mobile client devices, navigation and mapping systems, the global positioning system (GPS), security and access control systems, shipping and delivery systems, signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The subject matter described herein relates to an autonomous vehicle based transportation system having at least one driverless vehicle that is automatically controlled to carry passengers from one location to another. The disclosed subject matter provides certain enhanced features and functionality over conventional autonomous vehicle systems. To this end, an autonomous vehicle based transportation system can be modified, enhanced, or otherwise supplemented to provide the additional features mentioned in more detail below.

In general, the disclosure relates to systems and methods for determining when an autonomous passenger service reservation has concluded. The systems and methods determine when the reservation is complete and may send a confirmation to the user's mobile device. For example, a system is able to determine the end of the customer's journey and reservation by way of a range of sensory and other inputs. These inputs may include the presence of the customer in the vehicle, the amount of time static at the final journey destination, the customer's proximity around the exterior of the vehicle, among others. In some embodiments, there is no need for the customer to do anything after exiting the vehicle. Furthermore, the vehicle will know to proceed to the next geographical location (next reservation, maintenance/operations, staging lot, etc.) at the completion of the reservation.

In some embodiments, the vehicle conveys the arrival and the safety at the departure to the passenger when the vehicle reaches the destination. For example, the vehicle may detect and avoid or warn of obstacles, puddles, traffic, etc. at the destination. The vehicle may then prompt the passenger to take personal items with them at departure. In some embodiments, the vehicle or a server send a farewell massage including a timer indicating time to vehicle departure to a personal device of the passenger.

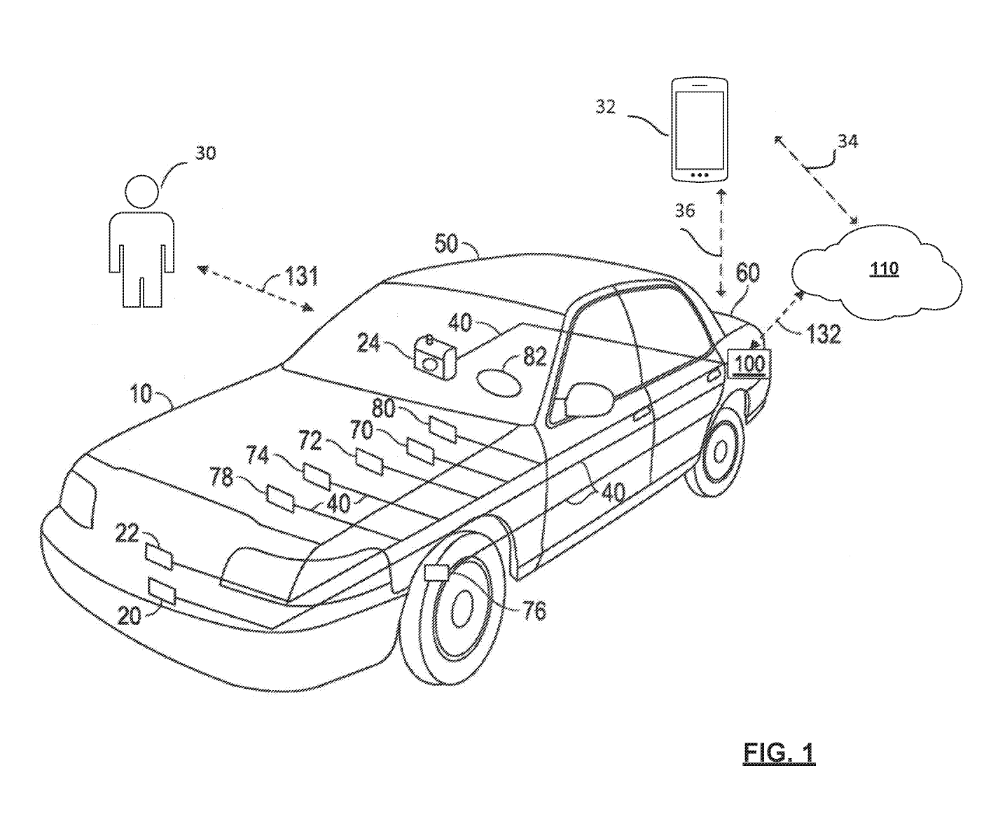

Referring now to FIG. 1, in accordance with exemplary embodiments of the subject matter described herein, an automated vehicle (or simply “vehicle”) 10 is illustrated. In this regard, the term “automated vehicle” as used herein generally refers to a vehicle that has an “automated” mode in which the vehicle 10 (through a suitable control system and any number of sensors) is configured to monitor its environment and navigate without human (e.g., driver or passenger) interaction. In some embodiments, vehicle 10 includes a “manual” mode that allows the passenger to assume manual control of the vehicle 10.

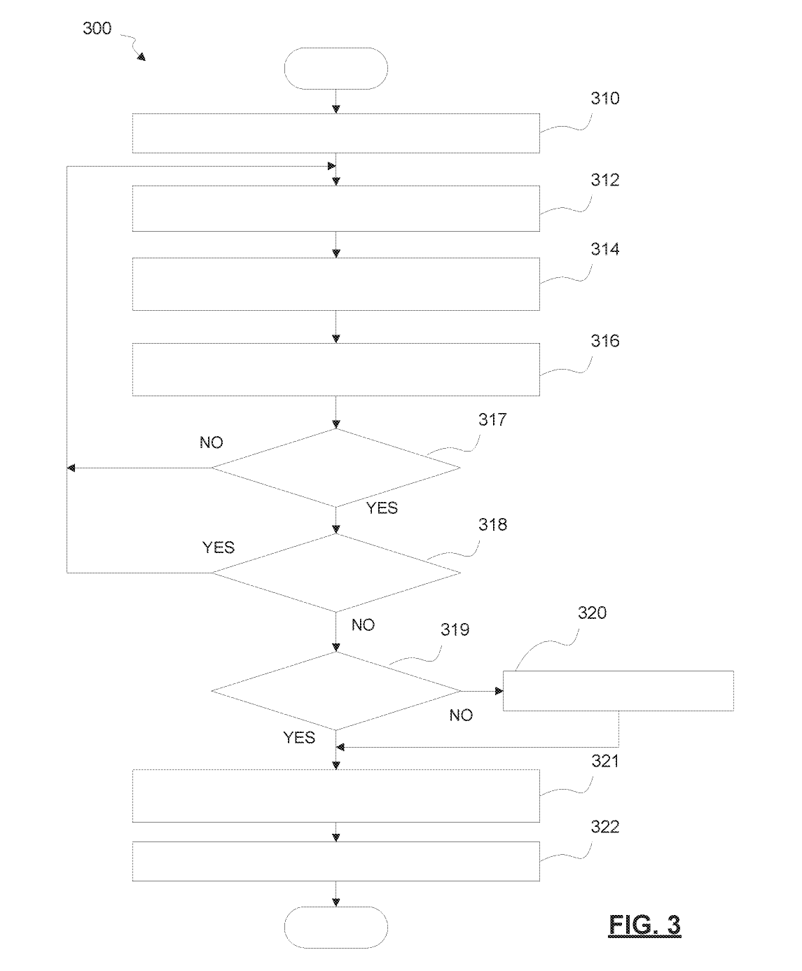

Vehicle 10 also includes an automated vehicle control system (or simply “control system”) 100. Control system 100 may operate in conjunction with or separate from one or more other automatic vehicle control systems, autonomous driving applications, or vehicle automated steering systems (not shown), such as a vehicle automated steering system providing, for example, adaptive lane centering, low speed lane centering, lane keeping assist, or other applications. Control system 100, when in an “automated mode” fully controls the steering and throttle of vehicle 10 without the need for driver steering control input via a steering wheel 82 and/or other components of the steering system. In general, control system 100 includes any suitable combination of hardware and/or software configured to receive sensor signals and perform the tasks described below with reference to FIG. 3.

Although the disclosure gives the example of an onboard control system 100 where vehicle 10 is controlled by commands, instructions, and/or inputs that are “self-generated” onboard the vehicle itself, the operations of vehicle 10 and tasks of FIG. 3 may alternatively or additionally be controlled by commands, instructions, and/or inputs that are generated by one or more components or systems external to the vehicle. For example, without limitation, vehicle 10 may be controlled by other autonomous vehicles, a backend server system, other control devices or systems located remotely from the vehicle, or the like. In certain embodiments, therefore, a given autonomous vehicle can be controlled using vehicle-to-vehicle data communication, vehicle-to-infrastructure data communication, and/or infrastructure-to-vehicle communication without departing from the scope of the present disclosure.

One or more sensors may be coupled to or associated with vehicle 10, including any combination of optical, proximity, occupancy, weight, audio, or other sensors. For example, the sensors may include a computer vision sensor (e.g., a camera) 24, a lidar or ladar sensor 20, a radar sensor 22, and/or any another remote sensing device useful in determining the relative location of vehicle 10 with respect to nearby people and features such as lane markers, road shoulder, median barriers, road edges, other vehicles, and the like. Camera 24 may, for example, measure lane offset, heading angle, lane curvature and/or other information (e.g., speed, acceleration, yaw-rate, other driver input etc.) and provide such information to control system 100. In some embodiments, a sensor signal output from camera 24 may be utilized to determine whether a departing passenger is facing towards or away from vehicle 10.

In one embodiment of the present disclosure, vehicle 10 may include one or more devices or sensors to measure the status or location of a departing passenger 30 at the conclusion of a reserved autonomous passenger service journey. In some embodiments, vehicle 10 communicates with a personal computing device 32 of passenger 30. For example, personal computing device 32 may communicate with control system 100 through a network 110 and data communication channels 34 and 132 utilizing a transceiver in vehicle 10. In various embodiments, the communication network 110 includes any number of public or private data connections, links or network connections supporting any number of communications protocols. The communication network may include the Internet, for example, or any other network based upon TCP/IP or other conventional protocols. In various embodiments, the communication network could also incorporate a wireless and/or wired telephone network, such as a cellular communications network for communicating with mobile phones, personal digital assistants, and/or the like.

In the example provided, personal computing device 32 also communicates directly with vehicle 10 through data communication channel 36. Data communication channel 36 may incorporate any sort of wireless or wired local and/or personal area networks, such as one or more IEEE 802.3, IEEE 802.16, and/or IEEE 802.11 networks, and/or networks that implement a short range (e.g., Bluetooth, near field communication, etc.) protocol. Vehicle 10 is illustrated with an occupancy sensor 70, a weight sensor 72, a microphone or audio sensor 74, an optical sensor 78, and a door closure sensor 80.

The measured distances, occupancies, weight, and other information may be transferred from the sensors to control system 100 as sensor signals via, for example, a wire link (e.g., a controller area network bus CAN bus, Flexray link, Ethernet link) 40 or a wireless link. Vehicle 10 will also generally include one or more internal displays 25 viewable by the passengers. As will be appreciated by those skilled in the art, in the interest of simplicity, various automated steering and throttle components commonly used in connection with automated vehicles have not been illustrated in FIG. 1.

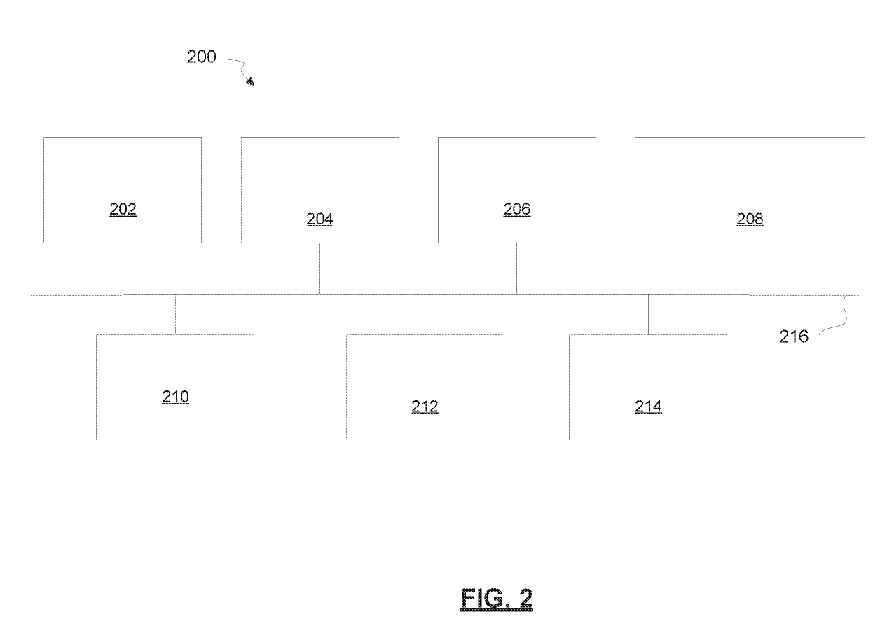

FIG. 2 illustrates components of control system 100 in accordance with some embodiments. Control system 100 is implemented as a processor-based or computer-based device, system, or component that is designed, configured, and programmed to meet the needs of the particular system or subsystem.

The illustrated embodiment of control system 100 includes, without limitation: a processor architecture 202 having at least one processor device; a suitable amount of memory 204, which includes at least one computer/processor readable media element; a data storage apparatus 206; device-specific hardware, software, firmware, and/or features 208; a user interface 210; a communication module 212; and a display element 214. Of course, control system 100 may include additional elements, components, modules, and functionality configured to support various features that are unrelated to the subject matter described here. For example, control system 100 may include certain features and elements to support conventional functions that might be related to the particular implementation and deployment of control system 100. In practice, the elements of control system 100 may be coupled together via a bus or any suitable interconnection architecture 218.

The processor architecture 202 may be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here. Moreover, the processor architecture 202 may be implemented as a combination of computing devices, e.g., a combination of a digital signal processor and a microprocessor, a plurality of microprocessors, one or more microprocessors in conjunction with a digital signal processor core, or any other such configuration.

The memory 204 may be realized as RAM memory, flash memory, EPROM memory, EEPROM memory, registers, a hard disk, a removable disk, a CD-ROM, or any other form of storage medium known in the art. In this regard, the memory 204 can be coupled to the processor architecture 202 such that the processor architecture 202 can read information from, and write information to, the memory 204. In the alternative, the memory 204 may be integral to the processor architecture 202. As an example, the processor architecture 202 and the memory 204 may reside in an ASIC. At least a portion of the memory 204 can be realized as a computer storage medium, e.g., a tangible computer readable media element having non-transitory processor-executable instructions stored thereon. The computer-executable instructions can be configurable such that, when read and executed by the processor architecture 202, cause control system 100 to perform certain tasks, operations, functions, and processes described in more detail herein. In this regard, the memory 204 may represent one suitable implementation of such computer-readable media. Alternatively or additionally, control system 100 could receive and cooperate with computer-readable media (not separately shown) that is realized as a portable or mobile component or platform, e.g., a portable hard drive, a USB flash drive, an optical disc, or the like.

The data storage apparatus 206 can be realized with the memory 204, or it can be implemented as a physically distinct component. The data storage apparatus 206 employs a nonvolatile storage technology to save and maintain data as needed. For example, the data storage apparatus 206 can include flash memory and/or a hard disk formatted to save data that is generated and used by the corresponding host system.

The device-specific hardware, software, firmware, and features 208 may vary from one embodiment of control system 100 to another. For example, the device-specific hardware, software, firmware, and features 208 will support telephone functions and features when control system 100 is realized as a mobile telephone, conventional personal computer functions and features if control system 100 is realized as a laptop or tablet computer, etc. In practice, certain portions or aspects of the device-specific hardware, software, firmware, and features 208 may be implemented in one or more of the other blocks depicted in FIG. 2. In some embodiments, control system 100 is a server storing instructions to perform the method of FIG. 3 through interaction with at least one remote device (e.g., mobile device, vehicle, etc.).

FIG. 3 is a flow chart that illustrates an exemplary embodiment of a method 300 for concluding a passenger service reservation in an autonomous vehicle. The various tasks performed in connection with the method 300 may be performed by software, hardware, firmware, or any combination thereof. For illustrative purposes, the following description of method 300 may refer to elements mentioned above in connection with FIGS. 1 and 2. In some embodiments, tasks of method 300 may be performed by alternative or additional devices. It should be appreciated that method 300 may include any number of additional or alternative tasks, that the tasks shown in FIG. 3 need not be performed in the illustrated order, and that method 300 may be incorporated into a more comprehensive procedure or process having additional functionality not described in detail herein. Moreover, one or more of the tasks shown in FIG. 3 could be omitted from an embodiment of method 300 as long as the intended overall functionality remains intact.

Vehicle 10 receives an indication of trip completion in task 310. The indication may be any receipt of data indicating that passenger 30 has completed the reservation. In some embodiments, the indication includes reaching a terminal destination according to a destination entered by passenger 30 at the beginning of, prior to, or during the reservation (in the event of a change of terminal destination). For example, vehicle 10 may determine that the terminal destination has been reached by comparing global navigation satellite system (GNSS) data with the GNSS data corresponding with the passenger's entered terminal destination. In some embodiments, the indication of trip completion may include an express command received through input devices and sensors of vehicle 10 by passenger 30. The indication of trip completion may include an attempt by passenger 30 to exit vehicle 10, such as by pulling an interior door handle of vehicle 10.

During the trip and after receiving the indication of trip completion, control system 100 receives at least one signal indicating a status of at least one passenger of the autonomous vehicle. In task 312, control system 100 receives sensor signals indicating the status of passenger 30. In the example provided, control system 100 receives an occupancy sensor signal from occupancy sensor 70 indicating whether a volume of space in a passenger compartment of the autonomous vehicle is currently occupied. In some embodiments, control system 100 receives a vehicle door sensor signal from door closure sensor 80 indicating whether a vehicle door has been opened and closed again. In some embodiments, control system 100 receives a weight sensor signal from weight sensor 72 indicating whether an object (e.g., luggage, purse) is resting on a seat in a passenger compartment of the autonomous vehicle. In some embodiments, control system 100 receives an audio sensor signal from microphone 74 indicating a verbal command from passenger 30. In some embodiments, control system 100 receives a proximity sensor signal indicting a distance 131 of passenger 30 from the autonomous vehicle. It should be appreciated that alternative and/or additional sensor signals may be received in task 312 without departing from the scope of the present disclosure.

Control system 100 receives wireless communication signals originating from a computer device associated with the at least one passenger in task 314. For example, control system 100 may receive signals from personal computing device 32 directly using data communication channel 35 utilizing NFC, Wi-Fi, BLUETOOTH, or other radio frequency protocols. Control system 100 may also receive signals from personal computing device 32 through network 110 and communication channels 34 and 132. In some embodiments, control system 100 receives an express command to conclude the reservation. For example, personal computing device 32 may have a software application that permits passenger 30 to expressly indicate that the reservation has completed. In some embodiments, control system 100 receives data from a global navigation satellite system (GNSS) associated with the computer device. For example, personal computing device 32 may send Global Positioning System (GPS) coordinates to control system 100.

In task 316, control system 100 processes the at least one signal to determine whether the at least one passenger has taken action consistent with completion of the reservation in the absence of an action that is inconsistent with completion of the reservation. For example, actions consistent with completion may include exiting vehicle 10, walking away from vehicle 10, staying outside of vehicle 10 for longer than a threshold amount of time, sending or speaking an express completion command, and other activities indicated by the received signals consistent with a passenger intention to complete the reservation. Actions that are inconsistent with completion of the reservation include occupancy of a passenger cabin by one or more passengers, remaining near vehicle 10 after exiting, express verbal or software communicated commands (e.g., “wait here”), among others.

In some embodiments, control system 100 processes a radio frequency signal received directly from the computer device to determine that the computer device has separated from the autonomous vehicle by a distance greater than a wireless direct communication range between the computer device and the autonomous vehicle. For example, when passenger 30 and vehicle 10 are in communications utilizing BLUETOOTH, control system 100 may determine that passenger 30 has exceeded the wireless direct communication range when the BLUETOOTH signal is lost after progressively losing signal strength consistent with walking away from vehicle 10.

When control system 100 determines in task 317 that an indication of trip completion was received, method 300 proceeds to task 318. When control system 100 determines in task 317 that no indication of trip completion was received, method 300 returns to task 310. When control system 100 determines in task 318 that no indication of reservation incompletion was received, then method 300 proceeds to task 321. When control system 100 determines in task 318 that an indication of reservation incompletion was received, then method 300 returns to task 310.

When control system 100 determines in task 318 that no indication of reservation incompletion was received, then method 300 proceeds to task 319. Control system 100 determines whether vehicle 10 is ready to depart in task 319. For example, control system 100 may determine whether vehicle 10 is ready to depart based on status of a closure panel (e.g., door, trunk, liftgate), based on items left behind by a passenger, based on a detected emergency situation within a period of time after passenger departure, or based on other criteria and determinations.

Control system 100 prepares for departure in task 320. In some embodiments, control system 100 prepares for departure by emitting a beacon to nearby users (e.g., passerby recipient) in response to detecting the previous passenger has concluded trip and departed, but left a closure panel open (e.g., door, trunk, liftgate). The beacon may request a passerby recipient to close the panel such that the vehicle may safely depart. For example, the beacon may be transmitted to the passerby recipient by an audible alert from vehicle 10, through software on a mobile device of the passerby recipient, or by other alerting methods. In some embodiments, the beacon offers a reward to the passerby recipient to assist vehicle 10 in departure preparation. For example, the beacon may offer a cash reward, ride credit, ride discounts, merchandise or goods, positive direct messaging, increased passenger rating, online social media postings, and other rewards. In some embodiments, the passenger who left the vehicle in a non-departure ready condition may be charged continued fare, a preparation surcharge, or other penalty.

In some embodiments, preparing for departure includes preventing departure in response to detection of a passenger item left behind in vehicle 10 (e.g., in passenger cabin or storage area as detected by weight sensors). For example, control system 100 may prevent departure and provide an alert to the departing passenger by a visible message, audible message, mobile device indication, or other suitable alerting method.

In some embodiments, preparing for departure includes taking emergency response action when control system 100 determines vehicle 10 is not ready due to detecting an emergency situation within a predetermined departure delay following departure of the previous passenger. For example, vehicle 10 may wait a specified amount of time after passenger departure and analyze sensor and mobile device signals to detect abrupt or aggressive movements, loud noises or voices, distress words, or other conditions indicating an emergency situation. In some embodiments, control system 100 may take emergency response action in response to a quick passenger return to vehicle 10 combined with a detected emergency situation. For example, control system 100 may lock the doors of vehicle 10 once the passenger has entered vehicle 10, may initiate quick departure without user prompt or instructions once passenger has entered vehicle 10, may contact a call center to engage customer care, or may take other suitable emergency response actions.

Control system 100 completes the reservation based on the processing the at least one signal in task 321. In response to completing the reservation, control system 100 may then initiate post reservation operations in task 322. For example, control system 100 may proceed with driving to the next reservation, to a maintenance facility, or to a staging lot in anticipation of a further reservation.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for passenger service in an autonomous vehicle, the method comprising:
receiving at least one signal indicating a status of at least one passenger of the autonomous vehicle;
processing the at least one signal to determine whether the at least one passenger has taken action consistent with completion of the passenger service reservation in the absence of an action that is inconsistent with completion of the passenger service reservation; and
completing the reservation based on the processing the at least one signal.

2. The method of claim 1, wherein receiving the at least one signal includes receiving at least one sensor signal from a sensor associated with the vehicle, and wherein processing the at least one signal includes processing the at least one sensor signal.

3. The method of claim 2, wherein receiving the at least one sensor signal includes receiving an occupancy sensor signal indicating whether a volume of space in a passenger compartment of the autonomous vehicle is currently occupied.

4. The method of claim 2, wherein receiving the at least one sensor signal includes receiving a vehicle door sensor signal indicating whether a vehicle door has been opened and closed again.

5. The method of claim 2, wherein receiving the at least one sensor signal includes receiving a weight sensor signal indicating whether an object is resting on a seat in a passenger compartment of the autonomous vehicle.

6. The method of claim 2, wherein receiving the at least one sensor signal includes receiving an audio sensor signal indicating a verbal command from the at least one passenger.

7. The method of claim 2, wherein receiving the at least one sensor signal includes receiving a proximity sensor signal indicting a distance of the at least one passenger from the autonomous vehicle.

8. The method of claim 1, wherein receiving the at least one signal includes receiving at least one wireless communication signal originating from a computer device associated with the at least one passenger.

9. The method of claim 8, wherein processing the at least one wireless communication signal includes processing a radio frequency signal received directly from the computer device to determine that the computer device has separated from the autonomous vehicle by a distance greater than a wireless direct communication range between the computer device and the autonomous vehicle.

10. The method of claim 8, wherein receiving the at least one wireless communication signal includes receiving an express command to conclude the reservation.

11. The method of claim 8, wherein receiving the at least one wireless communication signal includes receiving data from a global navigation satellite system (GNSS) associated with the computer device.

12. The method of claim 1, wherein processing the at least one signal is performed in response to reaching a terminal destination of the passenger service reservation.

13. The method of claim 1, further comprising emitting a beacon to nearby users requesting closing assistance with a closure panel in response to detecting:
departure by the at least one passenger;
reservation conclusion for the at least one passenger; and
an open condition of the closure panel.

14. The method of claim 13, wherein emitting the beacon includes offering a reward to the nearby users for completing the closing assistance of the closure panel.

15. The method of claim 13, further comprising penalizing the at least one passenger based on the open condition of the closure panel.

16. The method of claim 1, further comprising preventing departure of the autonomous vehicle and providing an alert to the at least one passenger in response to detection of a passenger item left behind in the autonomous vehicle upon departure of the at least one passenger.

17. The method of claim 1, further comprising imparting a predetermined delay in which the autonomous vehicle will not depart following departure of the at least one passenger.

18. The method of claim 17, further comprising:
detecting an emergency situation following departure of the at least one passenger; and
initiating an emergency response action in response to detection of the emergency situation and a return of the at least one passenger to the autonomous vehicle.

19. A server comprising:
a processor;
a transceiver in wireless communication with an autonomous vehicle; and
a non-transitory computer readable medium storing instructions that configure the server for:
interacting with at least one remote device;
transmitting to the autonomous vehicle, passenger service instructions associated with a passenger service reservation;
receiving at least one signal indicating a status of at least one passenger of the autonomous vehicle;
processing the at least one signal to determine whether the at least one passenger has taken action consistent with completion of the passenger service reservation in the absence of an action that is inconsistent with completion of the passenger service reservation;
completing the reservation based on the processing the at least one signal; and
transmitting an instruction to the autonomous vehicle authorizing departure from a terminal destination of the passenger service reservation.

20. An autonomous vehicle comprising:
a transceiver in wireless communication with an off-board server to receive passenger service instructions associated with a passenger service reservation;
a passenger cabin to house at least one passenger along a route corresponding to the passenger service instructions; and
a controller programmed to:
receive at least one signal indicating a status of at least one passenger,
process the at least one signal to determine whether the at least one passenger has taken action consistent with completion of the passenger service reservation in the absence of an action that is inconsistent with completion of the passenger service reservation,
transmit a reservation completion signal to the off-board server based on the processing the at least one signal, and
authorize departure of the autonomous vehicle from a terminal destination of the passenger service reservation based on the processing the at least one signal.
